(19) United States
(12) Patent Application Publication
(10) Pub. No.: US 2003/0008948 A1
(43) Pub. Date: Jan. 9, 2003

(54) Composite containing ABS

(76) Inventors: Edgar Leitz, Dormagen (DE); Harry Staratschek, Leverkusen (DE); Herbert Eichenauer, Dormagen (DE); Wolfgang Siebourg, Bonn (DE)

Correspondence Address: BAYER CORPORATION, PATENT DEPARTMENT, 100 BAYER ROAD, PITTSBURGH, PA, 15205, US

(21) Appl. No.: 10/161,808

(22) Filed: Jun. 4, 2002

(30) Foreign Application Priority Data
Jun. 7, 2001 (DE) 10127748.2

(51) Int. Cl. C08K 5/09

(52) U.S. Cl. 524/13; 524/323; 524/350; 524/290

(57) ABSTRACT

A composite containing I) an ABS component which contains

A) an ABS polymer and B) 0.05 to 5% by weight of at least one phenol which contains at least one sterically hindered hydroxyl group conforming to any of formulae (I) to (IV)

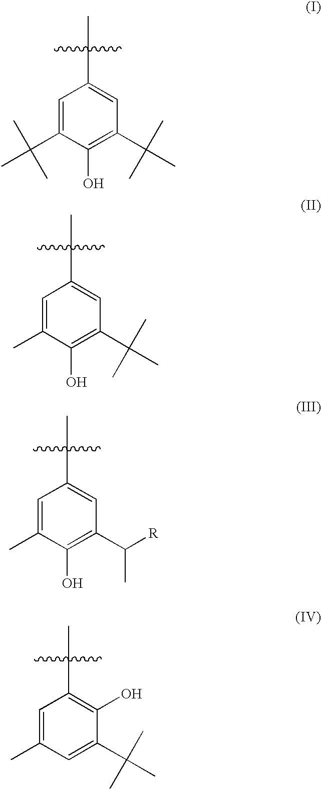

wherein R denotes a C₁₀-C₁₈ alkyl,

and II) at least one additional component selected from metals, other plastics, and from other materials is disclosed. The inventive composite features good bonding properties.

### FIELD OF THE INVENTION

This invention relates to composites containing an ABS component and at least one additional material, and to moldings which may be obtained from said composites.

### SUMMARY OF THE INVENTION

A composite containing I) an ABS component which contains

A) an ABS polymer and B) 0.05 to 5% by weight of at least one phenol which contains at least one sterically hindered hydroxyl group conforming to any of formulae (I) to (IV)

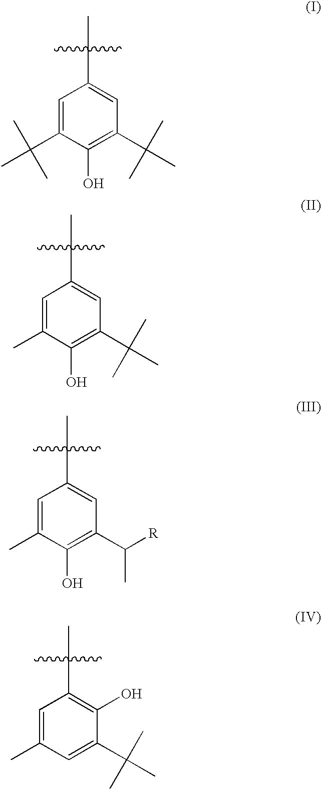

wherein R denotes a C₁₀-C₁₈ alkyl,

and II) at least one additional component selected from metals, other plastics, and from other materials is disclosed. The inventive composite features good bonding properties.

### BACKGROUND OF THE INVENTION

Polymers of the ABS type are two-phase plastics comprising

1) a thermoplastic copolymer of resin-forming monomers, e.g. styrene and acrylonitrile, wherein the styrene may be partially or completely replaced by α-methylstyrene or methyl methacrylate; this copolymer, which is also termed an SAN resin or matrix resin, forms the external phase;

2) at least one graft polymer which is produced by the graft reaction of one or more of the monomers cited in 1) on a butadiene homo- or copolymer (the “graft base”). This graft polymer (the “elastomer phase” or “graft rubber”) forms the disperse phase in the matrix resin.

ABS polymers 1) and 2) may be produced by known methods such as emulsion, solution, bulk, suspension or precipitation polymerization, or by a combination of methods such as these.

If composites are produced by the adhesive bonding of these ABS polymers, particularly ABS polymers in which at least one of components 1) and 2) has been produced by bulk or solution polymerization methods, this can result in inadequate bonding properties or in unwanted separation of the adhesively bonded layers.

The object of the present invention was therefore to provide composites comprising an ABS component and at least one additional material, which do not exhibit inadequate bonding properties.

### DETAILED DESCRIPTION OF THE INVENTION

Surprisingly, it has now been found that this object is achieved by means of ABS polymers which contain defined amounts of sterically hindered phenols.

The present invention thus relates to composites containing

I) an ABS component which contains

A) an ABS polymer and

B) 0.05 to 5% by weight, preferably 0.1 to 4% by weight, most preferably 0.5 to 3% by weight, with respect to 1), of at least one phenol which contains at least one sterically hindered hydroxyl group, selected from structural units of general formulae (I) to (IV)

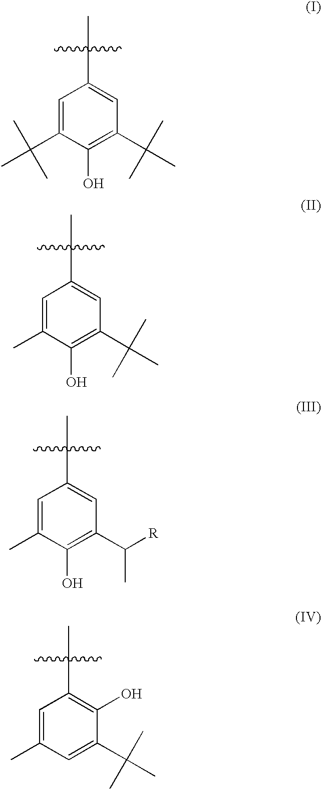

wherein R denotes a C₁₀-C₁₈ alkyl, and also containing

II) at least one additional material selected from metals, preferably aluminium or steel, other plastics, preferably polyvinyl chloride, polyalkylene terephthalates, polycarbonates, polyamides or polyolefines or mixtures thereof, most preferably polyethylene and polypropylene, as well as other materials, preferably wood.

Suitable ABS polymers contain

A.1) 5 to 100% by weight, preferably 7.5 to 80% by weight, most preferably 10 to 70% by weight of at least one graft polymer which is obtained by solution, suspension or bulk polymerization, or 5 to 80% by weight, preferably 7.5 to 70% by weight, most preferably 10 to 60% by weight of at least one graft polymer which is obtained by emulsion polymerization, and

A.2) 95 to 0% by weight, preferably 92.5 to 20% by weight, most preferably 90 to 30% by weight (when using a graft polymer which is obtained by solution, suspension or bulk polymerization), or 95 to 20% by weight, preferably 92.5 to 30% by weight, most preferably 90 to 40% by weight (when using a graft polymer which is obtained by emulsion polymerization) of at least one thermoplastic resin as described below.

Graft polymers in the sense of the present invention are those in which monomers or monomer mixtures selected from acrylonitrile, methacrylonitrile, maleic anhydride, an N-substituted maleinimide, styrene, α-methylstyrene, a styrene comprising a substituted nucleus or methyl methacrylate are graft-polymerized on to rubber (the graft base).

Suitable rubbers include practically all rubbers which have glass transition temperatures≦10° C., preferably those which contain polymerized butadiene. Examples include polybutadiene, styrene-butadiene polymers, acrylonitrile-butadiene polymers, acrylic rubbers, optionally comprising incorporated structural units derived from butadiene, and acrylate rubbers which contain, as their core, a crosslinked rubber such as polybutadiene or a copolymer of butadiene with an ethylenically unsaturated monomer such as styrene and/or acrylonitrile. Polybutadiene is preferred.

The graft polymers contain 3 to 95% by weight, particularly 5 to 70% by weight, of rubber, and 97 to 5% by weight, particularly 95 to 30% by weight, of graft-copolymerized monomers. In these graft polymers, the rubbers are present in the form of at least partially crosslinked particles with an average particle diameter (d₅₀) ranging from 0.05 to 20.0 μm, most preferably from 0.1 to 0.8 μm, wherein the average particle diameter d₅₀ may be determined by ultracentrifuge measurements (see W. Scholtan, H.

Lange: Kolloid.-Z. und Z. Polymere 250 (1972), 782-796).

Suitable methods of production include emulsion, solution, bulk or suspension polymerization routes; graft polymers A) which are produced by emulsion polymerization and/or solution or bulk polymerization are particularly preferred.

Thermoplastic polymers A.2) may be produced from monomers which are graft-polymerized on to the rubber (graft monomers) or from similar monomers, particularly from at least two monomers selected from styrene, α-methylstyrene, p-methylstyrene, halogenated styrenes, acrylonitrile, methacrylonitrile, methyl methacrylate, maleic anhydride, N-substituted maleinimides, particularly N-phenylmaleinimide, or mixtures thereof.

The preferred thermoplastic resins A.2) are preferably copolymers which may be obtained from 95 to 50% by weight styrene, α-methylstyrene or methyl methacrylate, or mixtures thereof, and 5 to 50% by weight acrylonitrile, methacrylonitrile, methyl methacrylate or maleic anhydride or mixtures thereof.

Particularly preferred thermoplastic copolymers, A.2) contain 20 to 40% by weight acrylonitrile and 80 to 60% by weight styrene or α-methylstyrene which are incorporated by polymerization. These copolymers are known. They preferably have molecular weights (M_{w}) of 15000 to 200,000 (as determined by gel permeation chromatography (GPC)).

Thermoplastic polymers A.2) are preferably produced by solution or bulk polymerization.

Particularly preferred ABS polymers A) are synthesized from

A.1.1 5 to 100% by weight of at least one graft copolymer obtained by solution, suspension or bulk polymerization, or 5 to 80% by weight of at least one graft copolymer obtained by emulsion polymerization, which are each produced by the graft-polymerization of

1.1 5 to 97% by weight of a mixture of

1.1.1 5 to 50% by weight acrylonitrile, methacrylonitrile, maleic anhydride, an N-substituted maleinimide or mixtures thereof, and

1.1.2 95 to 50% by weight styrene, α-methylstyrene, styrene comprising a substituted nucleus, methyl methacrylate or mixtures thereof, on

1.2 95 to 3% by weight of at least one rubber with a glass transition temperature T_{G}<10° C. and

A.1.2. 0 to 95% by weight (when using a graft copolymer obtained by solution, suspension or bulk polymerization) or 20 to 95% by weight (when using a graft copolymer obtained by emulsion polymerization) of at least one thermoplastic resin, produced by solution, suspension or bulk polymerization from

2.1 5 to 50% by weight acrylonitrile, methacrylonitrile, maleic anhydride, an N-substituted maleinimide or mixtures thereof, and

2.2 95 to 50% by weight styrene, α-methylstyrene, a styrene comprising a substituted nucleus, methyl methacrylate or mixtures thereof.

Compounds which contain at least one sterically hindered hydroxyl group suitable as component B) are known or may be produced by known methods. Examples of suitable compounds B) include known antioxidants conforming to formulae (V) to (XXV).

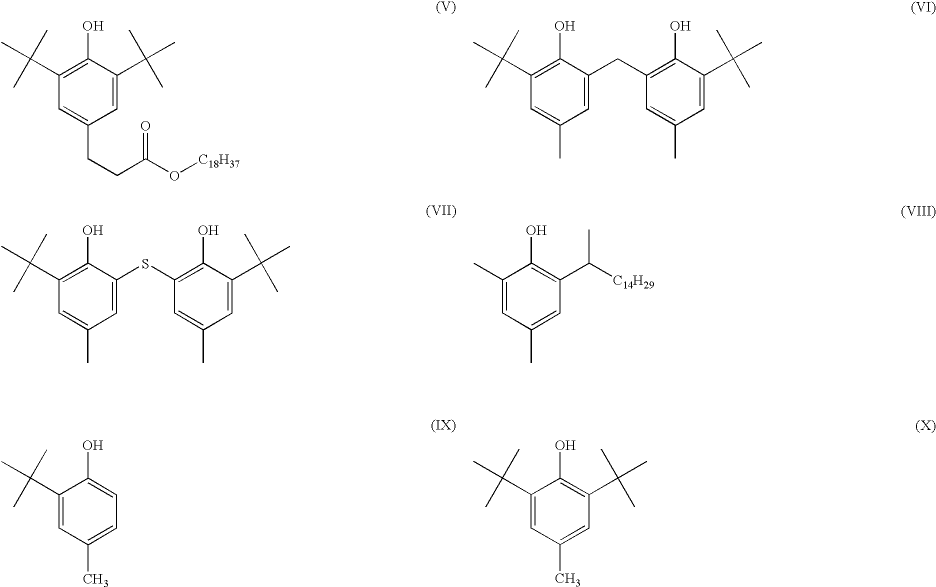

The compound of formulae (V) and (XIX) are particularly preferred, and are commercially available as Irganox® 1076, and Irganox® 245, respectively.

These compounds are admixed with the ABS polymer described above at elevated temperatures, e.g. from 100° to 300° C., in customary mixer units, kneaders, internal mixers, cylinder mills, continuous screw machines or extruders. The residence times employed for the mixing process may vary between 10 seconds and 30 minutes depending on the desired intensity of mixing.

In addition to the compounds which are used according to the invention, customary additives such as pigments, fillers, stabilisers, anti-static agents, internal lubricants, demolding agents, flame retardants and the like may be added to the ABS component.

The ABS component is preferably combined with other materials by adhesive bonding to form the composites according to the invention. The adhesives which are known to one skilled in the art for the adhesive bonding of composites are suitable for this purpose. Epoxy and acrylate adhesives are particularly preferred.

The composites according to the invention are suitable for the production of moldings, sheeting and panels.

Examples of moldings of this type include laminates which consist of sheets or panels which are built up from two or more layers, e.g. from metal and plastics layers.

### EXAMPLES

All parts are given as parts by weight.

1. Components Used

A.1) A graft rubber comprising 50% by weight polybutadiene with an average particle diameter (d₅₀) of 0.35 μm on to which 36.5% by weight styrene and 13.5% by weight acrylonitrile were graft-polymerized in an emulsion.

A.2) A graft rubber comprising 50% by weight polybutadiene with an average particle diameter (d₅₀) of 0.1 μm on to which 36.5% by weight styrene and 13.5% by weight acrylonitrile were graft-polymerized in an emulsion.

A.3) Styrene/acrylonitrile (SAN)=72:28—a copolymer with an average molecular weight (M_{w}) of about 85,000, produced by solution polymerization.

A.4) styrene/acrylonitrile (SAN)=72:28—a copolymer with an average molecular weight (M_{w}) of about 85,000, produced by emulsion polymerization.

B.1) Irganox® 1076 (Ciba, Basle, Switzerland)

B.2) Irganox® 245 (Ciba, Basle, Switzerland)

C.1) Polyvinyl alcohol (Mowiol® 26-88, Hoechst AG)

C.2) The sodium salt of a mixture of resin acids (sodium salt of Dresinatee® 731, Abieta Chemie GmbH, Gersthofen)

C.3) Maleic anhydride

2. Production and Testing of Molding Compositions

The parts by weight of the individual polymer components given in Table 1 were mixed with the additives which are also listed in Table 1 and with 0.5 parts by weight of ethylenediamine bis-stearylamide in an internal kneader at 200° C. to 230° C. for 3 to 5 minutes, and were subsequently granulated.

The granules were pressed at 195° C. to form panels about 0.5 mm thick. The sheets which were cut therefrom were then adhesively bonded on one side to an aluminium sheet (about 1 mm thick ) and on the other side to a polyethylene film, using a two-component adhesive (Araldite® AW 136H supplied by Ciba, Basle, Switzerland, with hardener HY 994 supplied by Ciba, Basle, Switzerland). After the sheet-film composites had been adhesively bonded, they were cured in the press (under a loading of 10 t) at 100° C. for 20 minutes, and were then cooled to room temperature while maintaining the same press loading.

The bonding strength was evaluated qualitatively 2 days after the adhesive had cured. The following ranking of the bonding strength was employed:

+: composite could not be separated manually (good bonding)

0: composite could be partially separated manually (poor bonding)

−: composite could easily be separated manually (no bonding)

The assessment of the bonding strength tests which is also given in Table 1 shows that the ABS polymers according to the present invention exhibit very good bonding when they are adhesively bonded both to metals and to polyolefines.

TABLE 1
Compositions of ABS polymers and test results (bonding strength)
of composites produced therefrom.

| | | | | | | | | | | Bonding |
|---|---|---|---|---|---|---|---|---|---|---|
| Example | A.1 | A.2 | A.3 | A.4 | B.1 | B.2 | C.1 | C.3 | C.3 | strength |
| 1 | 33.5 | 33.5 | 33 | — | 2 | — | — | — | — | + |
| 2 | 33.5 | 33.5 | 33 | — | — | 2.5 | — | — | — | + |
| 3 (comp.) | 33.5 | 33.5 | 33 | — | — | — | 2 | — | — | − |
| 4 (comp.) | 33.5 | 33.5 | 33 | — | — | — | — | 2 | — | − |
| 5 (comp.) | 33.5 | 33.5 | 33 | — | — | — | — | — | 2 | 0 |
| 6 (comp.) | 33.5 | 33.5 | 33 | — | — | — | — | — | — | − |
| 7 (comp.) | 33.5 | 33.5 | — | 33 | — | — | — | — | — | 0 |
| 8 | 33.5 | 33.5 | — | 33 | 1.5 | — | — | — | — | + |

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A composite comprising
I) an ABS component which contains
A) an ABS polymer and
B) 0.05 to 5% relative to the weight of 1) of a phenol which contains at least one sterically hindered hydroxyl group selected from the group consisting of formulae (I) to (IV) 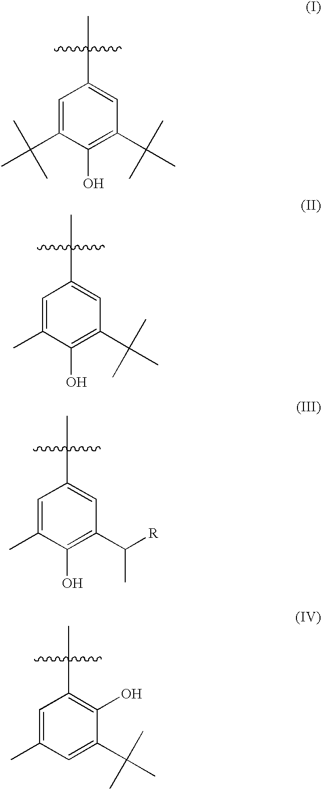
wherein R denotes a C₁₀-C₁₈ alkyl, and
II) at least one additional component selected from the group consisting of metals, resinous polymer different from ABS polymer, ceramics and wood.

2. The composite according to claim 1, wherein the ABS polymer A) contains
1. at least one graft copolymer produced by the graft-polymerization of
1.1 5 to 97% relative to the weight of the graft copolymer of a mixture of
1.1.1 5 to 50% relative to the weight of the mixture of at least one member selected from the group consisting of acrylonitrile, methacrylonitrile, maleic anhydride and N-substituted maleinimide, and
1.1.2 95 to 50% relative to the weight of the mixture of at least one member selected from the group consisting of styrene, α-methylstyrene, a styrene comprising a substituted nucleus, and methyl methacrylate, on
1.2 95 to 3% relative to the weight of the graft copolymer of at least one rubber having a glass transition temperature<10° C. and
2. at least one thermoplastic resin produced by solution, suspension or bulk polymerization from
2.1 5 to 50% relative to the weight of the said thermoplastic resin of at least one member selected from the group consisting of acrylonitrile, methacrylonitrile, maleic anhydride and N-substituted maleinimide, and
2.2 95 to 50% relative t the weight of the said thermoplastic resin of at least one member selected from the group consisting of styrene, α-methylstyrene, a styrene comprising a substituted nucleus and methyl methacrylate,
with the provisos that the in the embodiments where the graft copolymer is a product of solution, suspension or bulk polymerization the amount of the graft copolymer is 5 to 100 percent and the amount of the thermoplastic resin is 0 to 95 percent, and in the embodiments where the graft copolymer is
a product of emulsion polymerization the amount of the graft copolymer is 5 to 80 percent and the amount of the thermoplastic resin is 20 to 95 percent, said percent, all occurrences, being relative to the weight of the ABS polymer.

3. The composite according to claim 1, wherein phenol conforms structurally to

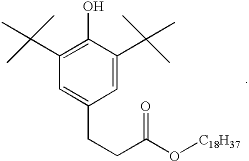

4. The composite according to claim 1, wherein the phenol conforms structurally to

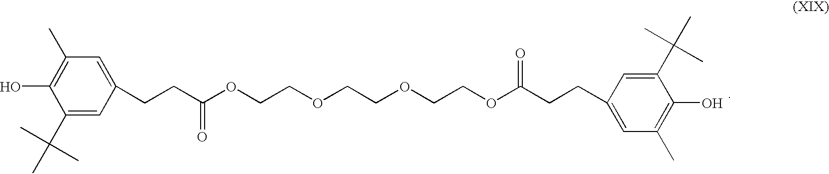

5. The composite according to claim 1, wherein the additional component is a member selected from the group consisting of aluminum, steel, polyvinyl chloride, polyethylene terephthalate, polybutylene terephthalate, polycarbonate, polyamide, polyethylene and polypropylene, and wood.

6. The composite according to claim 1, wherein the ABS component is adhesively bonded to the additional component.

7. The composite according to claim 1, wherein the ABS component is adhesively bonded to the additional component by an epoxy or acrylate adhesive.

8. A method of using the ABS component of claim 1 comprising producing a composite.

9. A method of using the composite according to claim 1 comprising producing a molded article.

10. A molded article comprising the composite of claim 1.
